(19) United States
(12) Patent Application Publication
(10) Pub. No.: US 2019/0188156 A1
(43) Pub. Date: Jun. 20, 2019

(54) STRIPE ALIGNED CACHE FLUSH

(71) Applicant: Seagate Technology LLC, Cupertino, CA (US)

(72) Inventors: Kishore Kaniyar Sampathkumar, Bangalore (IN); Vipin Kumar Verma, Jhansi (IN)

(21) Appl. No.: 15/846,562

(22) Filed: Dec. 19, 2017

(51) Int. Cl. G06F 12/128; G06F 12/0871

(52) U.S. Cl. CPC G06F 12/128; G06F 2212/604; G06F 2212/621; G06F 12/0871

(57) ABSTRACT

Implementations described herein provide a storage system including a cache, such as a solid-state cache or other relatively higher speed memory cache, and a disc array or relatively higher capacity mass data store. As the storage system receives write requests from a host device, the data of the write requests is initially written to the cache. Eventually, such data is committed to the mass data store in a flushing process. A flushing manager selects data blocks from the cache to flush to the mass data store. The flushing manager selects a sequence of data blocks that are contiguously stored on the mass data store such as to increase performance for I/O operations in the mass data store. The flushing manager utilizes a data structure, such as a binary search tree, to identify the contiguous data blocks to flush.

### BACKGROUND

Storage systems may include data storage devices for caching data before the data is committed to a main store, such as a disc array. Contiguous segments of data, as stored in the cache, are selected for flushing to the main store. The flush data, as stored in contiguous locations in the cache may not be optimal for writing to the main store.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

A storage device includes a memory, one or more processors, and a flushing manager. The flushing manager is stored in the memory and is executable by the one or more processors to identify one or more dirty blocks from the from one or more cache windows of a solid-state cache for flushing to a disc array including a plurality of discs storing one or more data stripes. Each data stripe of the disc array is allocated to the plurality of discs. The identification of the one or more data blocks is responsive to determining that the one or more dirty data blocks are contiguous in a data stripe of the one or more data stripes. The discrimination uses a data structure referencing the one or more cache windows.

These and various other features and advantages will be apparent from a reading of the following Detailed Description.

### BRIEF DESCRIPTIONS OF THE DRAWINGS

FIG. 1 illustrates a block diagram of an example storage system implementing stripe aligned cache flush.

FIG. 2 illustrates an example implementation of a metadata table, data structure, and writes for stripe aligned cache flush.

FIG. 3 illustrates example operations for identifying adjacent blocks for stripe aligned cache flush.

FIG. 4 illustrates a schematic of a storage controller of a storage system.

### DETAILED DESCRIPTION

Implementations described herein provide a storage system including a cache, such as a solid-state drive (SSD) or other relatively higher speed data storage device, and a disc array or relatively higher capacity mass data store. As the storage system receives write requests from a host device, the data of the write requests can be initially written to the cache. Eventually, such data is committed to the disc array in a flushing process in some embodiments. A flushing manager selects data blocks from the cache to flush to the disc array. The flushing manager selects a sequence of data blocks that are contiguously stored on the disc array such as to increase performance for I/O operations in the disc array. The flushing manager utilizes a data structure, such as a binary search tree, to identify the contiguous data blocks to flush.

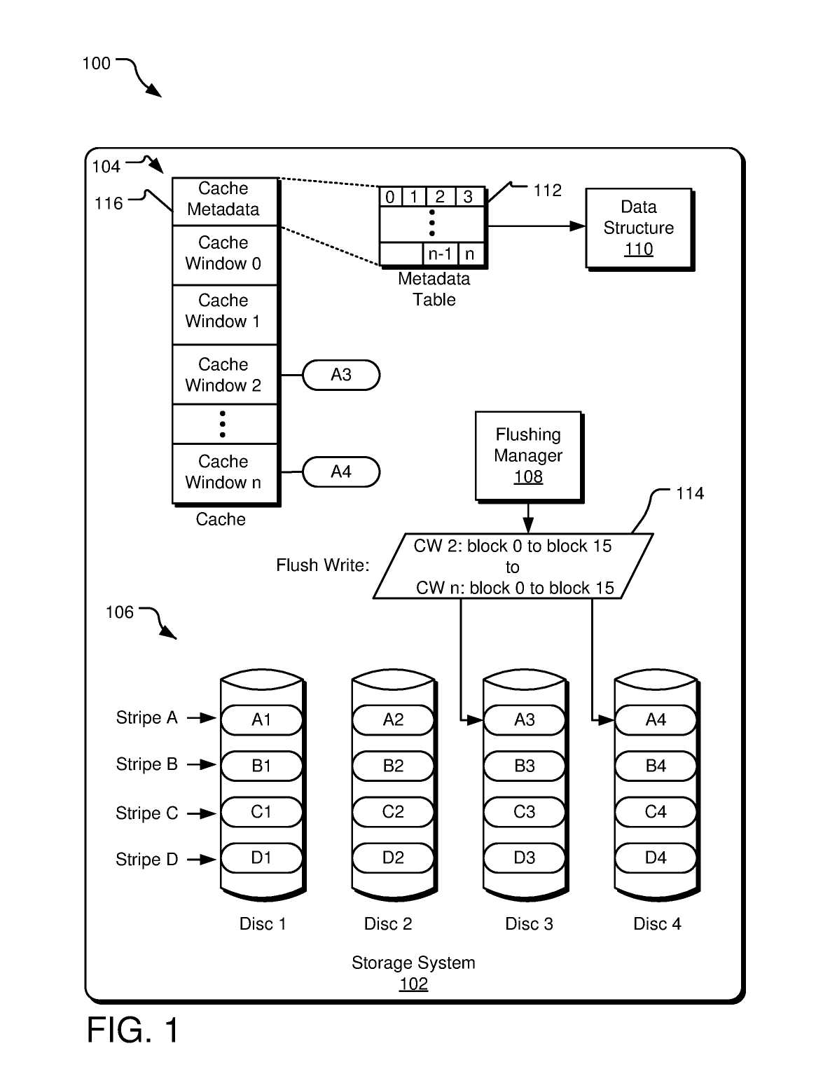

FIG. 1 illustrates a block diagram 100 of an example storage system 102 implementing stripe aligned cache flush. The storage system includes a cache 104 and a disc array 106 (e.g., a mass data store). One or more virtualized data storage volumes may be stored in the storage system 102. In some example implementations, the cache 104 is implemented as one or more non-volatile solid-state memory devices or flash devices such as solid-state drive (SSD) devices. The cache 104 is used for storing read/write data that may include frequently or recently accessed data as well as recently received data (e.g., from a host) and allocated to the one or more virtualized data storage volumes. The cache may be implemented as one or more separate storage devices/storage media that are configured for different data such as read hot data, write hot data, etc.

The disc array 106 includes a number of discs (e.g., disc 1 to disc 4) that are configured as the “main store” of the storage system, as the disc array 106 stores a large capacity of data compared to the cache 104. In some example implementations, the disc array 106 is configured is a redundant array of independent discs (RAID). The discs of the disc array 106 may be magnetic or optical discs or capacity optimized solid-state memory discs and be implemented as racks, cylinders, etc. including a plurality of discs. In some example implementations, one or more discs or disc sectors are configured to provide parity sectors for data recovery upon a disc/disc surface failure. Each disc or a plurality of discs may be implemented as a hard disc drive (HDD) device. In some example implementations, the cache 104 is a 1-3 terabyte (TB) cache and the array of discs 106 are configured to store 150 to 200 TBs of data and may include 36-100 discs, for example. However, it should be understood that the implementations described herein may be utilized in varying capacities of caches and main stores and may include fewer or more discs than indicated or illustrated.

The one or more virtualized storage volumes of the storage system 102 are stored across the disc array 106 based on a volume logical block addressing (V LBA) scheme. For example, a first storage volume may be accessed using a first range of V LBAs and may be stored across varying sectors of disc 1 to disc 4. Similarly, a second storage volume may be accessed using a second range of V LBAs and may be stored across varying sectors of disc 1 to disc 4. Groups or segments of logically sequential data may be separated into different physical storage devices such as to improve the speed of I/O operations. For example, if an I/O operation is directed to a segment of logically sequential addresses and the logically sequential addresses are stored on a single physical storage device, then the single device takes time to process the full I/O operation. In contrast, if the segment of logically sequential addresses is stored across a plurality of physical storage devices, then the processing is allocated between the separate physical storage devices, which improves I/O performance.

A sequence of logical addresses that are allocated across a plurality of storage devices of a storage system is referred to as a data stripe. The disc array 106 of the storage system 102 includes stripe A to stripe D. It should be understood that a particular storage system may include a greater or fewer number of storage stripes as illustrated. Furthermore, it should be understood that a storage stripe may be allocated to a subset of discs in a disc array. A capacity of a data stripe depends on a variety characteristics of a storage sub-systems. The characteristics include, without limitation, the size, arrangement, configuration, and number of discs in the disc array. An optimal I/O operation to the disc array may be determined based on a data stripe. For example, an I/O operation that includes continuous addresses in stripe A of the disc array 106 is processed faster than an I/O operation that includes varying addresses in stripe B and stripe D. An operation that writes to a complete stripe is optimal because it writes an entire stripe of data (e.g., a large capacity), but the entire stripe is allocated across the plurality of discs. In some example implementations, a data stripe consists of 1 MiB of data. As such, an optimal write operation for such an implementation is a 1 MiB write. Furthermore, it should be understood that a data stripe may “wrap” around the plurality of discs. For example, an example data stripe of disc array 106 consists of segments A3, A4, B1, and B2, where each segment is on a separate physical disc. However, such an example stripe may not be “aligned,” as described below.

In the illustrated implementation, the 1 MiB write is allocated to each of the discs 1 to 4. For example, a 1 MiB write is divided between segments A1, A2, A3, and A4. A 1 MiB write is “aligned” for the best performance. An aligned data stripe write means that data of the data stripe is allocated to the first data sector of a stripe segment in a first disc and ends in a last sector of a stripe segment in the last disc. For example, an optimal/aligned 1 MiB write to the disc array 106 starts at the first data sector of data segment A1 and ends in the last data sector of segment A4 (e.g., A1, A2, A3, and A4). On the other hand, a sub-optimal I/O write is not “aligned” or misaligned. An example misaligned I/O operations starts on the fifth data sector of segment Al and ends on the fourth data sector of data segment B1 (e.g., A1, A2, A3, A4, B1). Such an I/O operation requires the disc 1 to perform two separate read/write operations (e.g., A1 and B1) and requires multiple parity calculations. Similarly, a 1 MiB stripe that starts in the first data sector in segment A4 and ends in the last data sector of segment B3 may also be sub-optimal (e.g., misaligned) because such a write requires multiple parity calculations (e.g., in RAIDS). In other words, the writes to segment A4 requires a parity calculation for stripe A, and the writes to segments B1-B3 have separate parity calculations for stripe B. As such, such a misaligned data stripe operation is sub-optimal.

The cache 104 is divided into a plurality of cache windows (CWs) that range from CW 0 to CW n. Each cache window consists of a plurality of smaller segments referred to as cache blocks or cache lines. In one example implementation, each cache block is a 4 KB block and each CW includes 16 blocks. Accordingly, each CW may include 64 KB of data.

Furthermore, each cache block may be 8 volume logical block addresses, in width, as allocated to the disc array. As such, each cache window may include 128 V LBAs, as allocated to the disc array (e.g., the volume). It should be understood that other data capacities for the CWs and cache blocks are contemplated (e.g., 32 KB cache windows). A portion of the cache 104 is designated for storing cache metadata. The portion is referred to as a cache metadata region 116. The cache metadata region 116 includes a metadata table 112. The metadata table 112 includes entries for each cache window (e.g., CW 0 to CW n). Each entry of the metadata table 112 includes a parameter or field that identifies a device number (e.g., virtualized virtual volume number and/or disc number) and a block number (e.g., a logical block address) for the data in the virtualized virtual volume where the data of the cache window is allocated. Furthermore, each entry of the of the metadata table 112 further includes sub-entries for each cache block for the cache window. Each sub-entry includes a flag, parameter, field, etc. that indicates whether the data of the cache block is valid/invalid and whether the data of the cache block is clean/dirty. For example, a sub-entry includes a flag (e.g., a bit) indicating whether the corresponding data is valid or invalid (e.g., 1 or 0) and a flag indicating whether the corresponding data is clean or dirty (e.g., 1 or 0). In some example implementations, the cache blocks are referenced as clean/dirty valid/invalid using one or more bitmaps.

A cache block that is considered “valid” includes updated/current data as stored in the cache 104. A cache block that is considered invalid is not current in the cache and may be old or stale data. A cache block that is considered “clean” includes data that is stored in the cache 104 and also written to (e.g., committed to) the corresponding location in the disc array 106. A cache block that is considered “dirty” includes data that is current in the cache 104 and has not be written to/committed to the disc array 106. Thus, a given cache block may be in any one of the four states and may change states periodically during operation of the storage system 102.

On a periodic basis, a number of dirty cache blocks of the cache 104 are “flushed” to the disc array 106. Flushing dirty data blocks refers to reading the data of the dirty blocks and writing/copying the data to the corresponding locations in disc array 106. A flushing manager 108 of the storage system 102 may determine when to flush dirty cache blocks and which dirty cache blocks to flush. In some example implementations, flushing is triggered after a number of dirty cache blocks reaches a threshold, which may be referred to a flushing condition.

The metadata table 112 may be used to determine the number of dirty cache blocks. In some example implementations, a cache window is considered dirty if it includes at least one dirty cache block.

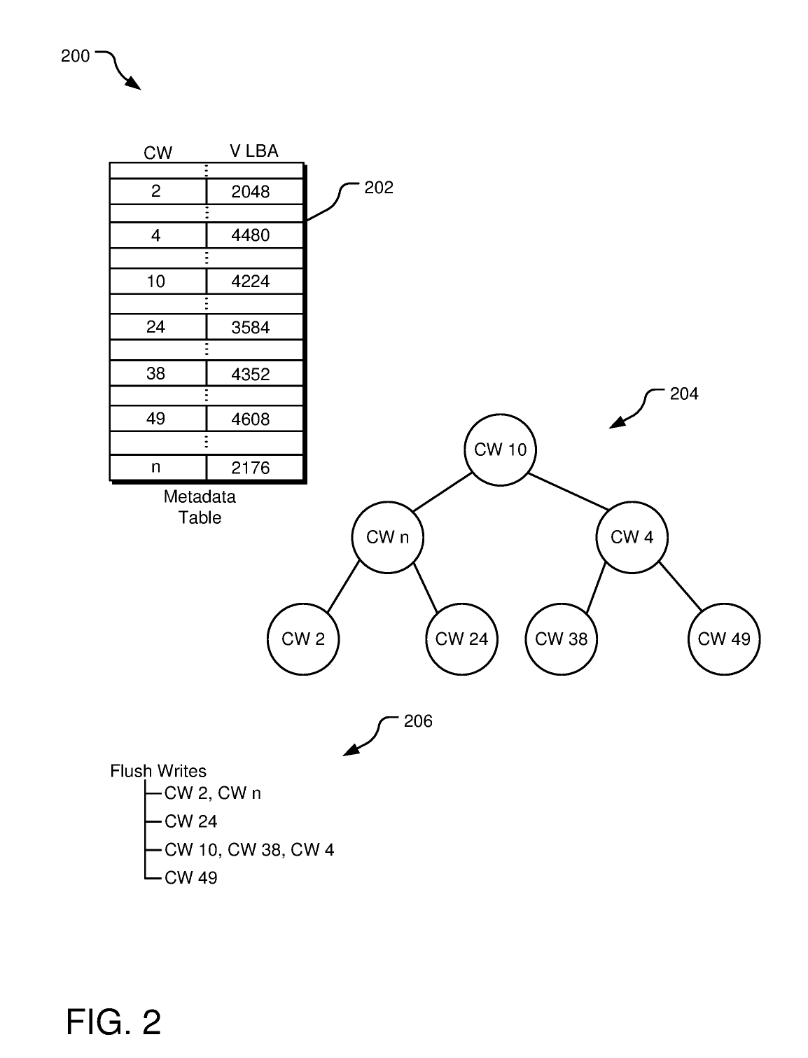

The flushing manager 108 (or an associated process) maintains a data structure 110 that includes, at least, references to cache windows that include dirty data blocks (e.g., dirty cache windows). Thus, when the state of a particular cache block is updated to dirty (e.g., contains recent data in the SSD cache as compared to the corresponding data on the backend virtual disc), and the cache block is the first cache block in a cache window to have a dirty status, then the cache window (a reference to the cache window) including the dirty data block is added to the data structure 110. The data structure 110 may be stored in the cache 104 (e.g., in the cache metadata region 116) or another volatile or non-volatile storage media of the storage system 102. In some example implementations, the data structure 110 is a binary tree where each node of the binary tree represents a cache window (see, for example, binary tree 204 of FIG. 2). In the example of the binary tree implementation, the binary tree is ordered based on the V LBA of the associated cache window. Thus, the flushing manager 108 reads the V LBA of a cache window using the metadata table 112 when the reference to the cache window is added to the binary tree.

When the cache 104 satisfies the flushing condition (e.g., when the flushing manager or another process determines that the number of cache blocks satisfies a threshold), the flushing manager 108 analyzes the data structure to identify dirty cache windows to flush. The flushing manager 108 is configured to attempt to identify dirty cache for an optimal flush. First, the flushing manager 108 attempts to identify a plurality of dirty cache blocks that are contiguous in a data stripe of the disc array 106. Accordingly, if a plurality of dirty data blocks comprises an entire data stripe (e.g., data stripe D) of the disc array 106 (e.g., an optimal I/O operation for the disc array 106), such dirty data blocks will be selected for flushing to the disc array 106. The flushing manager 108 may avoid flushing “misaligned” data stripes because such an operation may require multiple separate I/O operations on a single disc and/or multiple parity calculations, as described above.

If the flushing manager 108 is unable to identify a complete data stripe of dirty data blocks, then the flushing manager 108 attempts to identify another optimal grouping of dirty data blocks. Such an optimal grouping may include identifying a contiguous sequence of dirty data blocks allocated to a stripe. For example, if the flushing manager 108 identifies dirty data block that are allocated contiguously in sectors C2 and C3 of the disc array 106, then the flushing manager 108 may flush such blocks.

The flushing manager 108 uses the data structure 110 to identify contiguous groupings of dirty data blocks. When a flush is triggered, the flushing manager 108 reads the first cache window referenced by the data structure 110. If all cache blocks of the cache window are dirty, then the flushing manager attempts to build a sequence of dirty cache blocks (e.g., sequence as allocated to the disc array 106) using the dirty cache blocks of the cache window. If a sequence already exists (e.g., the flushing manager already started building a sequence) and the current window is adjacent to the previously started sequence, then the dirty blocks of the cache window are concatenated or added to the sequence. If the current window is not adjacent to the previously started sequence, then the previously started sequence is flushed. The flushing manager 108 may start a new sequence with the dirty cache blocks of the current window or flush the current window. If sequence has not been previously initiated, then the flushing manager 108 starts a new sequence with the dirty cache blocks of the window and retrieves the next dirty window and repeats the process.

During the flushing process, the flushing manager 108 periodically (e.g., whenever a new cache window is analyzed) determines whether the current dirty window is allocated to a stripe boundary (e.g., the last cache block of the current dirty window is allocated to an end of a stripe segment). If the current dirty window is allocated to the stripe boundary, then the current window is flushed without attempting to build a sequence. Such a determination includes calculating the “end V LBA” of the current cache window being processed. The flushing manager 108 then determines if the end V LBA is a multiple of the size of a data stripe. If the end V LBA is a multiple of the size of the data stripe, then a stripe boundary has been reached. Other methods of determining whether a cache window ends on a stripe boundary are contemplated. Furthermore, if the current window does not include all dirty cache blocks, then the current window is flushed. The flushing manager 108 traverses the data structure 110 and performs such flushing operations until a threshold number of dirty cache windows are flushed to the disc array 106.

In some example implementations, if a cache window is flushed (e.g., based on the cache window ending on a stripe boundary or the cache window does not have all dirty data blocks), then only the dirty blocks of the cache window may be flushed. In other example implementations, if a cache window is flushed, then all blocks (dirty and clean) may be flushed.

When a flush is triggered by the flushing manager (e.g., a sequence ends), then the sequence is analyzed to build the flush write operation. Similarly, if the current cache window is not part of a sequence, the sequence is analyzed to build the write operation and the current cache window is analyzed to build the write operation. The data of cache windows being flushed are read from the cache 104 and added to a buffer for the flush write operation (e.g., batched). After the flush write operation is constructed, a disc array controller (not shown) writes the flush write operation to the disc array 106.

In the implementation illustrated in FIG. 1, a flush is triggered by the number of dirty data blocks in the cache 104. The flushing manager 108 reads the data structure 110 to coalesce dirty data blocks. The flushing manager 108 determines that cache window 2 includes all dirty data blocks and that the dirty data blocks are allocated to sector A3 on the disc array 106. The flushing manager may analyze the metadata table 112 to determine the location of the cache blocks on the disc array 106. The flushing manager 108 further determines that the cache window n includes all dirty data blocks and that the dirty data blocks are allocated to sector A4 on the disc array. Because the blocks of cache windows 2 and cache window n are allocated to sectors A3 and A4, respectively, the cache windows are adjacent and the data blocks are continuous on the disc array 106. The flushing manager 108 reads the next cache window in the data structure 110 and determines that the cache window is not adjacent to the cache window n. As such, a flush is triggered and the flushing manager 108 builds a write operation 114. The write operation 114 includes cache block 0 to cache block 15 of the cache window 2 and cache block 0 to cache block 15 of the cache window n. The write operation 114 is sent to the disc array 106, where the data is written to sectors A3 and A4. It should be understood that a number of cache windows may be allocated to a single sector (e.g., A2). As such, determining adjacency of cache windows may include determining adjacency within a sector.

The above described implementations are utilized to imporove the storage system by constructing a sequence of dirty cache blocks that are aligned and coalesced within a data stripe in the disc array 106. The flushing manager attempts to build the optimal flush write (e.g., an entire aligned data stripe) and if it does not find the most optimal write, then finds the next optimal write (e.g., a sequence of dirty cache blocks in a stripe, a cache window). The flushing manager 108 continues to process through the data structure 110 to construct optimal/less optimal writes until a sufficient number of dirty cache blocks are flushed. Such implementations provide improve in the storage system 102 by increasing read/write performance of the storage system 102.

It should be understood that other types of data structures may be utilized to document dirty cache windows in order. For example, an array or linked list of references to dirty cache windows may be used. When a flush is triggered, the flushing manager 108 traverses the array or linked list and flushes appropriate contiguous dirty cache blocks as they contiguous sequences are encountered. Other types of data structures for documenting and flushing cache blocks are contemplated.

FIG. 2 illustrates an example implementation 200 of a metadata table 202, data structure 204, and writes 206 for stripe aligned cache flush. The metadata table 202 is a partial metadata table as it includes entries for cache windows that include at least one dirty data block. Furthermore, the metadata table 202 does not illustrate the sub-entries for each of the data blocks of the cache window. The metadata table 202 may be stored in a metadata region of a cache of a storage system. Similarly, the data structure 204 may be stored in the metadata region of a cache of a storage system or in another volatile or non-volatile storage media of the storage system. The metadata table 202 and the data structure 204 may be controlled and managed by a cache controller and/or a flushing manager of the storage system.

The flushing manager uses the metadata table 202 and the data structure 204 to select one or more dirty data blocks to flush from the cache to a disc array of the storage system. The flushing manager attempts to build one or more contiguous sequences of dirty cache blocks to flush to the disc array for optimal writes and increased performance. When a cache flush is triggered (e.g., based a threshold number of cache blocks in the cache being dirty), then the flushing manager begins the flushing processes and flushes dirty data blocks until a threshold number of dirty blocks are flushed from the cache.

In the illustrated implementation, the data structure 204 is a binary search tree, wherein each node represents a cache window of the cache. The binary tree is ordered based on the volume logical block address (e.g., location) of each cache window as allocated to the disc array. In the illustrated implementation, each cache window has a “width” if 128 volume logical block addresses (V LBAs) allocated on the disc array. As such, the V LBA on the metadata table 202 may indicate the starting V LBA of the cache window. It should be understood that other capacities of cache windows are contemplated. For example, cache window two is allocated to V LBA 2048 and cache window n is allocated to V LBA 2176. As such, cache window 2 is a child node of cache window n in the data structure 204. Similarly, cache window 24 is allocated to V LBA 3584, which is before V LBA 4224 (V LBA for cache window 10). Thus, cache window 24 is a child (right) node of cache window n, which is a child node of cache window 10. The binary search tree may be a height-balanced binary search tree such as an AVL tree.

When the flush is triggered, the flushing manager traverses the data structure 204 (in order). When each node in the data structure is encountered, the flushing manager determines whether all cache blocks of the cache window are dirty (e.g., using the metadata table 202). The flushing manager also determines whether the cache window ends on a stripe boundary of the disc array. Accordingly, the flushing manager reads cache window 2 and first determines whether the cache window includes all dirty cache blocks. In the illustrated implementation, the flushing manager determines that all cache blocks of cache window 2 are dirty and does not end on a stripe boundary. Thus, the flushing manager initiates a sequence of dirty blocks with the dirty blocks of cache window 2. The flushing manager then reads cache window n and determines that it includes all dirty cache blocks and does not end on a stripe boundary. The flushing manager further determines that cache window n is adjacent to cache window 2 in the disc array (e.g., V LBA 2176 is adjacent to V LBA 2148). Because each cache window consists of 128 V LBAs, cache windows 2 and n are adjacent on the disc array. Thus, the flushing manager adds the dirty cache blocks of the cache window n to the previously initiated sequence including the cache blocks of cache window 2.

The flushing manager then reads cache window 24. Cache window 24 may include all dirty data blocks but the flushing manager determines that it is not adjacent to cache window n (e.g., the previous cache window) because there is a gap between the allocated V LBA ranges. Because the cache window 24 is not adjacent to the previously initiated sequence, a flush is triggered. When a flush is triggered, an initiated sequence is flushed (e.g., cache window 2 and cache window n). Furthermore, a current cache window is flushed. The writes 206 illustrate the first two write operations to the disc array. Cache window 2 and cache window n are flushed as a sequence of dirty cache blocks. Cache window 24 is flushed as cache window flush.

The flushing manager then flushes the cache blocks of cache windows 10, 38, and 4 as a sequence because the cache windows are allocated to adjacent V LBA ranges. Furthermore, cache windows 10 and 38 both do not end on a stripe boundary, allowing the cache manager to build the sequence. As illustrated, cache window 49 is allocated to V LBA 4608, which indicates that cache window 49 is adjacent to cache window 4 (e.g., V LBA 4480), as allocated to the disc array. Furthermore, the flushing manager determines that all the cache blocks of cache window 49 are dirty, but does not add the blocks of cache window 49 to the sequence, because cache window 4 ends on a stripe boundary. Thus, the sequence of cache window 10, 39 and 4 is flushed before cache window 49 is added to the sequence. As such, the write operations to the disc are optimized based on stripe boundaries.

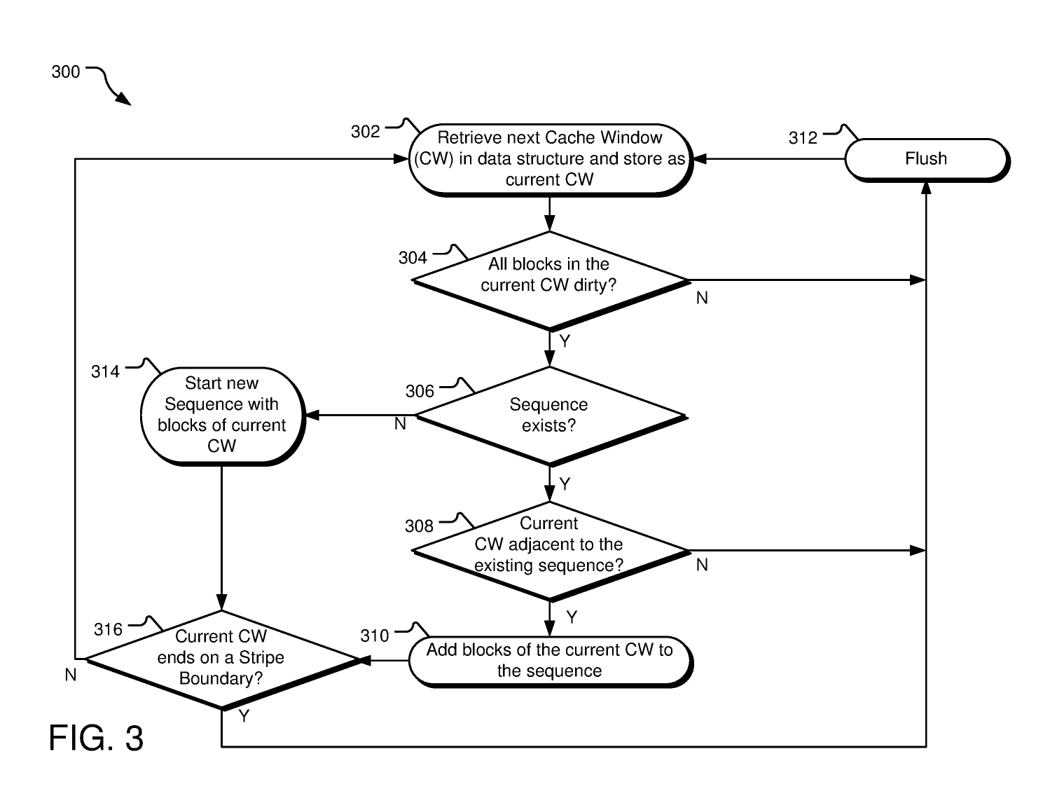

FIG. 3 illustrates example operations 300 for identifying adjacent blocks for stripe aligned cache flush. The operations 300 may be implemented by a flushing manager embodied in processor/computer readable instructions stored in a processor/computer readable media of a storage system. The operations 300 may be triggered when a threshold number of cache blocks of a storage system is considered “dirty.” Furthermore, the operations 300 may be repeated until a threshold number of dirty blocks are flushed. As such, each time a flush is triggered, the flushing manager may determine whether enough dirty blocks are flushed.

A retrieving operation 302 retrieves a next cache window (CW) in a data structure and stores the next CW as the current CW. The retrieving operation 302 may retrieve the next cache window in the data structure (e.g., a binary tree) based on an in-order traversal of the data structure. The data structure is ordered based on the volume logical block address as the cache window as allocated to the disc array. A determining operation 304 determines whether all block in the current CW are dirty. The flushing manager may analyze the metadata table and/or a dirty bitmap to make such a determination. If all the blocks in the current CW are not dirty, then a flushing operation 312 flushes the current cache window. If all the blocks in the current cache window are dirty, a determining operation 306 determines whether a sequence of dirty cache blocks exists (e.g., determines whether a sequence was previously initiated and has not been flushed).

If a sequence does not exist, then a starting operation 314 starts a new sequence with the blocks of the current CW. Another determining operation 316 determines whether the current CW ends on a stripe boundary of the disc array. If the current CW does not end on a stripe boundary, then the retrieving operation 302 retrieves the next cache window in the data structure and stores the next cache window as the current CW. The process is repeated and the sequence is constructed with additional blocks if the next cache window includes all dirty windows and is adjacent to the previous cache window. If the current CW ends on a stripe boundary (as determined in the determining operation 316), then the flushing operation 312 is triggered.

If the sequence does exit, then a determining operation 308 determines whether the current CW is adjacent to the existing sequence. If the current CW is adjacent to the existing sequence, then an adding operation 310 adds the blocks of the current CW to the existing sequence. The determining operation 316 determines whether the current cache window end on a stripe boundary of the disc array, then either the next window is retrieved in the retrieving operation 302 or a flush is triggered in the flushing operation 312. If the current CW is not adjacent to the existing sequence (as determined in the determining operation 308), then the flushing operation 312 is triggered and the flushing operation 312 flushes the current CW and the existing sequence.

When the flushing operation 312 is triggered, the flushing manager flushes a sequence, if it exists, and flushes the current cache window. Thus, the flushing manager determines whether a sequence exists and flushes the sequence upon determining that it exists. Furthermore, the flushing manager flushes the current cache window during the flushing operation 312. Furthermore, the flushing manager may determine whether a threshold number of data blocks have been flushed after each flushing operation 312.

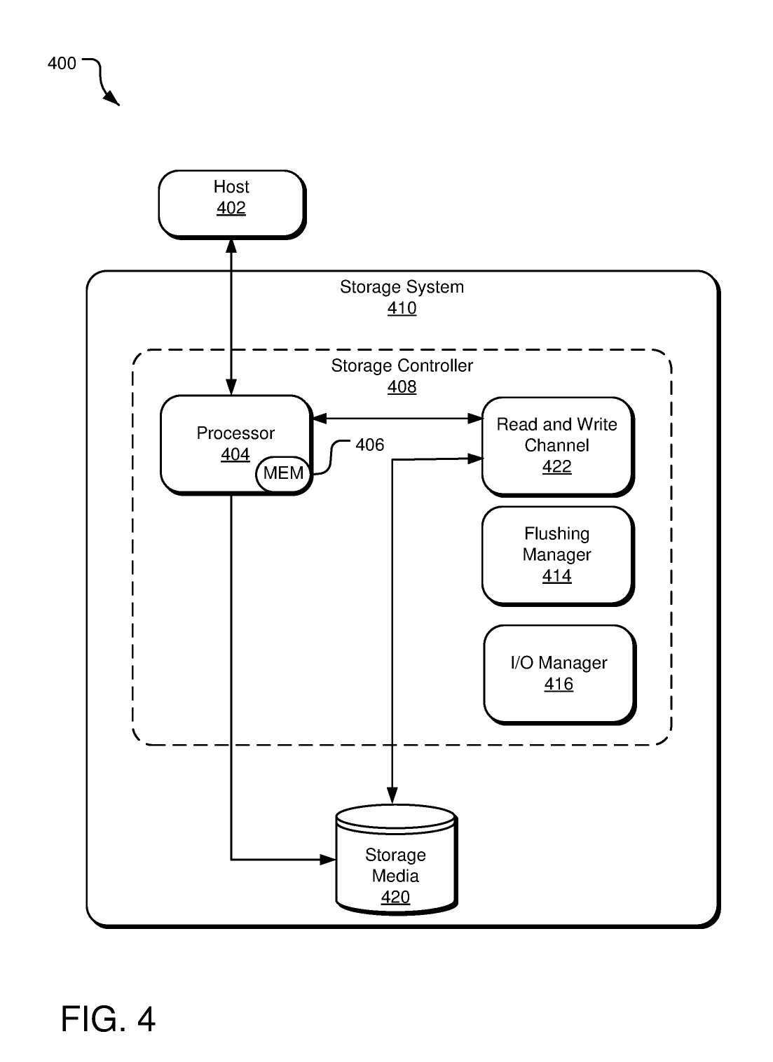

FIG. 4 illustrates an example schematic 400 of a storage controller 408 of a storage system 410. Specifically, FIG. 4 shows one or more functional circuits that are resident on a printed circuit board used to control the operation of the storage system 410. The storage controller 408 may be operably and communicatively connected to a host computer 402, which may include the storage system 410 or may be separate from the storage system. Control communication paths are provided between the host computer 402 and a processor 404. Control communication paths are provided between the processor 404 and the storage devices 420 via a number of read/write channels (e.g., read and write channel 422). The processor 404 generally provides top-level communication and control for the storage controller 408 in conjunction with processor-readable instructions for the processor 404 encoded in processor-readable storage media (e.g., a memory 406). The processor readable instructions further include instructions for performing stripe aligned flushing and instructions for caching data, etc.

The term “processor-readable storage media” includes but is not limited to, random access memory (“RAM”), ROM, EEPROM, flash memory or other memory technology, CDROM, digital versatile discs (DVD) or other optical disc storage, magnetic cassettes, magnetic tape, magnetic disc storage or other magnetic storage devices, or any other tangible medium which can be used to store the desired information and which can be accessed by a processor. In contrast to tangible processor-readable storage media, intangible processor-readable communication signals may embody processor-readable instructions, data structures, program modules or other data resident in a modulated data signal, such as a carrier wave or other signal transport mechanism.

The storage controller 408 controls storage of data on the storage devices 420 such as HDDs, SSD, SSHDs, flash drives, SATA drives, disc arrays, etc. Each of the storage devices may include spindle motor control circuits for controlling rotation of media (e.g., discs) and servo circuits for moving actuators between data tracks of storage media of the storage devices 420.

Other configurations of storage controller 408 are contemplated. For example, storage controller 408 may include one or more of an interface circuitry, a buffer, a disc drive, associated device peripheral hardware, an encryption unit, a compression unit, a replication controller, etc. The storage controller 408 includes a flushing manager 414 that confirms satisfaction of flushing conditions, identifies and coalesces dirty cache blocks, etc. The storage controller 408 manages read/write operations, caching, etc. of the storage system 410. The flushing manager 414 and the I/O manager 416 may be embodied in processor-readable instructions stored in the memory 406 (a processor-readable storage media) or another processor-readable memory.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology.

Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of storage, such as hard disc media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A storage system comprising:
a memory;
one or more hardware processors; and
a flushing manager stored in the memory and executable by the one or more hardware processors to determine, using a data structure referencing one or more cache windows of a solid-state cache, that one or more data blocks from the one or more cache windows are contiguous in a data stripe of one or more data stripes stored in a plurality of discs of a disc-array, each data stripe allocated to the plurality of discs, and
in response to the determination, identify the one or more dirty data blocks from the one or more cache windows for flushing to the disc array.

2. The storage system of claim 1 wherein the one or more cache windows are referenced by the data structure based on the one or more cache windows including at least one dirty data block.

3. The storage system of claim 1 wherein the data structure is a binary tree of the one or more cache windows, the binary tree of the one or more cache windows storing the references to the one or more cache windows in an order based on a logical block address of the one or more cache windows as allocated to the disc array.

4. The storage system of claim 3 wherein the flushing manager traverses the binary tree of the one or more cache windows to identify the one or more contiguous dirty data blocks.

5. The storage system of claim 4, wherein the flushing manager builds a sequence of the one or more dirty blocks as the flushing manager traverses the binary tree of the one or more cache windows.

6. The storage system of claim 4 wherein the flushing manage traverses the binary tree of the one or more cache windows until a threshold number of dirty data blocks are flushed to the disc array.

7. The storage system of claim 1 wherein the flushing manager determines whether the one or more dirty data blocks are aligned in the data stripe before identifying the one or more dirty data blocks for flushing to the disc array.

8. A method comprising:
determining that one or more dirty data blocks from one or more cache windows of a cache are contiguous in a data stripe of a mass data store, the determination using a data structure referencing the one or more cache windows, the data stripe allocated to the mass data store; and
flushing the one or more dirty data blocks to the data stripe allocated to the mass data store.

9. The method of claim 8 wherein the one or more cache windows are referenced by the data structure based on the one or more cache windows including at least one dirty data block.

10. The method of claim 8 wherein the data structure is a binary tree of the one or more cache windows of a solid-state memory cache, the binary tree storing references to one or more dirty cache windows in an order based on a logical block address of the one or more dirty cache windows as allocated to the mass data store comprising a disc array.

11. The method of claim 10 further comprising:
traversing the binary tree of the one or more dirty cache windows to identify the one or more dirty data blocks.

12. The method of claim 11 further comprising:
adding dirty data blocks of a current cache window to a sequence of one or more dirty cache blocks as the binary tree is traversed.

13. The method of claim 11 further comprising:
determining whether a current cache window referenced by the binary tree ends on a stripe boundary of the data stripe; and
responsive to determining that the current cache window ends on the stripe boundary of the data stripe, flushing the current cache window to the disc array.

14. The method of claim 10 further comprising:
traversing the binary tree of the one or more cache windows to identify the one or more dirty data blocks until a threshold number of dirty data blocks are flushed to the disc array.

15. One or more processor-readable storage media encoding processor-executable instructions for executing on a computer system a process to improve the computer system comprising:
determining that one or more dirty data blocks from one or more cache windows of a solid-state cache are contiguous in a data stripe a disc array including a plurality of discs, the determination using a data structure referencing the one or more cache windows, the data stripe allocated to the plurality of discs; and
flushing the one or more dirty data blocks to the data stripe allocated to the plurality of discs in the disc array.

16. The one or more processor-readable storage media of claim 15 wherein the one or more cache windows are referenced by the data structure based on the one or more cache windows including at least one dirty data block.

17. The one or more processor-readable storage media of claim 15 wherein the data structure is a binary tree, the binary tree storing the references to the one or more cache windows in an order based on a logical block address of the one or more cache windows as allocated to the disc array.

18. The one or more processor-readable storage media of claim 15, the computer process further comprising:
traversing the data structure of the one or more cache windows to identify the one or more dirty data blocks; and
adding dirty data blocks of a current cache window to a sequence of one or more dirty cache blocks as the data structure is traversed.

19. The one or more processor-readable storage media of claim 15, the computer process further comprising:
determining whether a current cache window referenced by the data structure ends on a stripe boundary of the data stripe; and
responsive to determining that the current cache window ends on the stripe boundary of the data stripe, flushing the current cache window to the disc array comprising a relatively higher capacity mass data store.

20. The one or more processor-readable storage media of claim 15, the computer process further comprising:
traversing the data structure to identify the one or more dirty data blocks until a threshold number of dirty data blocks are flushed to the disc array.
